(19) United States
(12) Patent Application Publication
(10) Pub. No.: US 2026/0355766 A1
(43) Pub. Date: Nov. 12, 2026

(54) DISCHARGE DEVICE

(71) Applicant: YOSHINO KOGYOSHO CO., LTD., Tokyo (JP)

(72) Inventor: Shinya MAEDA, Koto-ku, Tokyo (JP)

(73) Assignee: YOSHINO KOGYOSHO CO., LTD., Tokyo (JP)

(21) Appl. No.: 19/119,656

(22) PCT Filed: Sep. 1, 2023
(86) PCT No.: PCT/JP2023/032133

§ 371 Date: Apr. 9, 2025

(30) Foreign Application Priority Data
Nov. 28, 2022 (JP) 2022-189522

(51) Int. Cl. B05B 11/10; F04B 9/14

(52) U.S. Cl. CPC B05B 11/1038; B05B 11/1001; F04B 9/14

(57) ABSTRACT

A discharge device (1) includes: a first cylinder (24); a first piston (3) configured to slide on the first cylinder (24); a second cylinder (4) attached to a mouth (20a) of a container body (20); a second piston (25) configured to slide on the second cylinder (4); a holding member (16) configured to advance and retract along with the first cylinder (24) and the second piston (25) relative to the second cylinder (4) in response to an external operation and, during the advancement and retraction, advance and retract along with the first piston (3) relative to the first cylinder (24); an internal flow path (18) through which contents inside the container body (20) are discharged via a pump chamber (18a) defined by the first cylinder (24), the first piston (3), the second cylinder (4), and the second piston (25), in accordance with the advancement and retraction of the holding member (16); a pressure accumulating portion (17) configured to close the internal flow path (18) by seating of a seating portion (3a) of the first piston (3) in an advancing direction against a seated portion (6a) of the holding member (16) due to urging by a first urging member (13); and a second urging member (14) configured to urge the holding member (16) in a retracting direction relative to the second cylinder (4).

### TECHNICAL FIELD

The present disclosure relates to a discharge device.

### BACKGROUND

A discharge device is known that includes: a cylinder; a piston slidable on the cylinder; a holding member that advances and retracts along with the piston relative to the cylinder in response to an external operation; an internal flow path through which the contents inside a container body are discharged via a pump chamber defined by the cylinder and the piston, in accordance with the advancing and retracting movement of the holding member; and a pressure accumulating portion that closes the internal flow path by seating of a seating portion of the piston in an advancing direction against a seated portion of the holding member due to urging by an urging member (see, for example, JP 2002-35654 A (PTL 1)).

### CITATION LIST

### Patent Literature

PTL 1: JP 2002-35654 A

### SUMMARY

### Technical Problem

When designing the foregoing conventional pressure accumulation-type discharge device to achieve a large discharge (spray) volume, problems such as an increase in the stroke of the cylinder and an increase in the operating force to be applied to the holding member arise.

It could therefore be helpful to provide a pressure accumulation-type discharge device capable of easily achieving a large discharge volume.

### Solution to Problem

A discharge device according to the present disclosure includes: a first cylinder; a first piston configured to slide on the first cylinder; a second cylinder attached to a mouth of a container body; a second piston configured to slide on the second cylinder; a holding member configured to advance and retract along with the first cylinder and the second piston relative to the second cylinder in response to an external operation and, during the advancement and retraction, advance and retract along with the first piston relative to the first cylinder; an internal flow path through which contents inside the container body are discharged via a pump chamber defined by the first cylinder, the first piston, the second cylinder, and the second piston, in accordance with the advancement and retraction of the holding member; a pressure accumulating portion configured to close the internal flow path by seating of a seating portion of the first piston in an advancing direction against a seated portion of the holding member due to urging by a first urging member; and a second urging member configured to urge the holding member in a retracting direction relative to the second cylinder.

In the discharge device according to the present disclosure having the above configuration, it is preferable that the holding member includes: a stem being tubular and extending in an advancing/retracting direction; a piston guide attached to an inner peripheral surface of the stem and including the seated portion; and a continuous portion provided integrally on the stem radially outward from the stem and configured to be urged in the retracting direction by the second urging member.

In the discharge device according to the present disclosure having the above configuration, it is preferable that the first urging member includes a compression spring configured to be compressed by the continuous portion and the first piston in the advancing/retracting direction.

In the discharge device according to the present disclosure having the above configuration, it is preferable that the continuous portion is configured to press the first cylinder in the advancing direction at an advancement limit position relative to the first cylinder.

In the discharge device according to the present disclosure having the above configuration, it is preferable that the second urging member is configured to urge the first cylinder in the retracting direction via an engaging portion between the continuous portion and the first cylinder.

In the discharge device according to the present disclosure having the above configuration, it is preferable that the internal flow path includes a discharge port through which the contents are discharged in a mist form.

### Advantageous Effect

It is thus possible to provide a pressure accumulation-type discharge device capable of easily achieving a large discharge volume.

### BRIEF DESCRIPTION OF THE DRAWINGS

In the accompanying drawings:

FIG. 1 is a longitudinal sectional view illustrating a discharge container including a discharge device according to one embodiment of the present disclosure in a pre-operation state;

FIG. 2 is a longitudinal sectional view illustrating a state when an operation of pressing down a nozzle head of the discharge container illustrated in FIG. 1 is started;

FIG. 3 is a longitudinal sectional view illustrating a state when the nozzle head is further pressed down from the state illustrated in FIG. 2; and

FIG. 4 is a longitudinal sectional view illustrating a state when the nozzle head is further pressed down from the state illustrated in FIG. 3.

### DETAILED DESCRIPTION

Embodiments of the present disclosure will be described by way of examples below, with reference to the drawings.

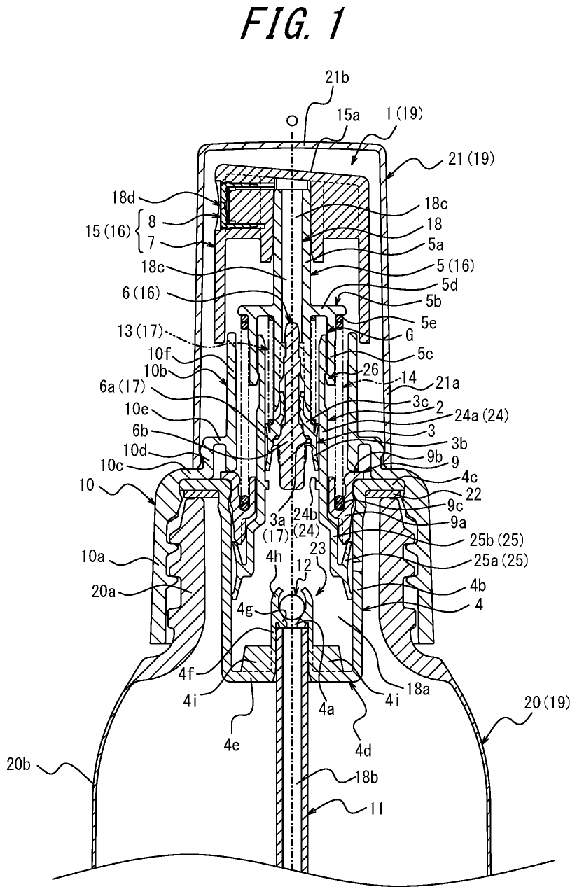

As illustrated in FIG. 1, in one embodiment of the present disclosure, a discharge device 1 includes: a first cylinder/second piston member 2, a first piston 3, a second cylinder 4, a stem member 5, a piston guide 6, a head body 7, a nozzle tip 8, a locking member 9, a mounting cap 10, and a pipe 11, each integrally formed of, for example, resin; and a valve body 12, a first urging member 13, and a second urging member 14, each integrally formed of, for example, metal. The head body 7 and the nozzle tip 8 constitute a nozzle head 15. The nozzle head 15, the stem member 5, and the piston guide 6 constitute a holding member 16. A seating portion 3a of the first piston 3, a seated portion 6a of the piston guide 6, and the first urging member 13 constitute a pressure accumulating portion 17. The valve body 12, the first urging member 13, and the second urging member 14 are not limited to being made of metal, and may be made of resin, for example.

The discharge device 1 includes an internal flow path 18. The internal flow path 18 includes a pump chamber 18a, an upstream flow path 18b, and a downstream flow path 18c. The downstream flow path 18c includes a discharge port 18d.

In this embodiment, a discharge container 19 includes the discharge device 1, a container body 20, and an upper lid 21.

The container body 20 includes a cylindrical mouth 20a centered on a central axis O of a first cylinder 24 described later, a body 20b connected to a lower end portion of the mouth 20a, and a bottom connected to a lower end portion of the body 20b. The mouth 20a may have a tubular shape other than cylindrical, such as a rectangular tubular shape. Liquid contents are contained within the container body 20.

In this embodiment, a direction along the central axis O is also referred to as an advancing/retracting direction or a vertical direction, a direction from the mouth 20a to the bottom in the advancing/retracting direction is also referred to as an advancing direction or a downward direction, the opposite direction is also referred to as a retracting direction or an upward direction, a direction along a straight line perpendicular to the central axis O is also referred to as a radial direction, a direction around the central axis O is also referred as a circumferential direction, and a section including the central axis O is also referred to as a longitudinal section.

The second cylinder 4 has a larger diameter than the first cylinder 24, and includes an inlet port 4a. The second cylinder 4 is attached to the mouth 20a by attaching the mounting cap 10 to the mouth 20a. The second cylinder 4 also includes: a second cylinder body 4b having a tubular shape centered on the central axis O and contacting the second piston 25; a flange 4c extending radially outward from an upper portion of the second cylinder body 4b and arranged on the upper end surface of the mouth 20a via a packing 22; and a second cylinder bottom 4d extending radially inward from a lower portion of the second cylinder body 4b and including the inlet port 4a.

The second cylinder bottom 4d includes: a bottom wall 4e extending radially inward from the lower portion of the second cylinder body 4b and having an annular shape centered on the central axis O; a bottom tubular portion 4f extending upward from an inner peripheral edge portion of the bottom wall 4e and having a tubular shape centered on the central axis O; a valve seat portion 4g extending radially inward from an upper end portion of the bottom tubular portion 4f and including the inlet port 4a on the central axis O to have the valve body 12 seated thereon; a valve restricting portion 4h extending upward from an outer peripheral edge portion of the valve seat portion 4g and configured to restrict the valve body 12 from rising upward away from the valve seat portion 4g; and a plurality of longitudinal ribs 4i arranged at spacings in the circumferential direction and each extending on the upper surface of the bottom wall 4e excluding its outer peripheral edge portion and on the outer peripheral surface of the bottom tubular portion 4f in the radial direction and the vertical direction.

The pipe 11 has an upper end portion attached to the inner peripheral surface of the bottom tubular portion 4f by fitting.

The valve body 12, the valve seat portion 4g, and the valve restricting portion 4h constitute an inlet valve 23. The inlet valve 23 allows movement of the contents from inside the container body 20 to the pump chamber 18a when the valve body 12 moves upward away from the valve seat portion 4g, and prevents movement of the contents in the reverse direction when the valve body 12 moves downward to seat on the valve seat portion 4g. The inlet valve 23 is not limited to a configuration including the valve body 12, the valve seat portion 4g, and the valve restricting portion 4h, and may include, for example, an elastic valve such as a three-point valve.

The mounting cap 10 includes: a peripheral wall 10a attached to the outer peripheral surface of the mouth 20a; and a cap upper portion 10b extending radially inward from an upper portion of the peripheral wall 10a so as to contact the upper surface of the flange 4c and having an annular shape centered on the central axis O. The cap upper portion 10b includes: a lower annular wall 10c extending radially inward from an upper end portion of the peripheral wall 10a so as to contact the upper surface of the flange 4c; an outer tubular wall 10d extending upward from an inner peripheral edge portion of the lower annular wall 10c; an upper annular wall 10e extending radially inward from an upper end portion of the outer tubular wall 10d; and an inner tubular wall 10f extending upward and downward from an inner peripheral edge portion of the upper annular wall 10e.

The first cylinder/second piston member 2 has an annular shape centered on the central axis O, and has an upper end portion constituting the first cylinder 24 and a lower end portion constituting the second piston 25.

The second piston 25 includes a second sliding tube 25a and a second tubular shaft 25b. The second sliding tube 25a constitutes an outer peripheral edge portion of the second piston 25, and slides in the vertical direction on the inner peripheral surface of the second cylinder body 4b. The second tubular shaft 25b constitutes an inner peripheral edge portion in the radial direction of the second piston 25, and has a tubular shape extending in the vertical direction. The second tubular shaft 25b has a lower end portion integrally connected to the second sliding tube 25a and an upper end portion integrally connected to a lower end portion of the first cylinder 24.

The locking member 9 has an annular shape centered on the central axis O, is integrally attached to the second cylinder 4, and restricts the second piston 25 from slipping upward out of the second cylinder 4. More specifically, the locking member 9 includes: a locking portion 9a having an outer peripheral surface contacting the inner peripheral surface of the second cylinder body 4b; and a protruding portion 9b protruding radially outward from an upper portion of the locking portion 9a and having a lower surface facing the upper surface of the second cylinder 4. The locking portion 9a, on its upper surface, includes a lower receiving portion 9c that has an annular concave shape centered on the central axis O and receives a lower end portion of the second urging member 14.

The second piston 25 is restricted from slipping upward out of the second cylinder 4 by the second piston 25 abutting upward against the locking portion 9a. Downward misalignment of the locking member 9 relative to the second cylinder 4 is restricted by the protruding portion 9b abutting downward against the upper surface of the second cylinder 4. Upward misalignment of the locking member 9 relative to the second cylinder 4 is restricted by the part of the locking portion 9a located radially outward from the lower receiving portion 9c abutting upward against the lower end surface of the inner tubular wall 10f of the mounting cap 10.

The second urging member 14 is centered on the central axis O and includes a compression spring that expands and contracts in the vertical direction.

The first cylinder 24 has an annular shape centered on the central axis O, and includes a first cylinder body 24a and a restricting stepped portion 24b. The first cylinder body 24a has a tubular shape centered on the central axis O and contacts the first piston 3. The restricting stepped portion 24b protrudes radially inward from a lower end portion of the first cylinder body 24a in a stepped shape.

The holding member 16 advances and retracts (i.e., moves in the advancing direction and the retracting direction) along with the first piston 3 and the second piston 25 relative to the second cylinder 4, in response to an external operation via the nozzle head 15. During the advancing and retracting movement, the holding member 16 also advances and retracts along with the first piston 3 relative to the first cylinder 24.

The holding member 16 includes: a stem 5a being tubular and extending in the advancing/retracting direction about the central axis O; the piston guide 6 attached to the inner peripheral surface of the stem 5a and including the seated portion 6a; and a continuous portion 5b provided integrally on the stem 5a radially outward from the stem 5a and urged in the retracting direction by the second urging member 14. The stem 5a and the continuous portion 5b constitute the stem member 5.

The piston guide 6 has a rod shape extending in the advancing/retracting direction about the central axis O. The piston guide 6 includes a large-diameter portion 6b that increases in diameter below the stem 5a. The large-diameter portion 6b includes the seated portion 6a.

The first piston 3 has an annular shape centered on the central axis O, and includes a first sliding tube 3b and a first tubular shaft 3c. The first sliding tube 3b constitutes an outer peripheral edge portion of the first piston 3, and slides on the inner peripheral surface of the first cylinder body 24a in the advancing/retracting direction. The first tubular shaft 3c constitutes an inner peripheral edge portion in the radial direction of the first piston 3, has a tubular shape extending in the advancing/retracting direction, and has a lower end portion integrally connected to the first sliding tube 3b. The first tubular shaft 3c surrounds the outer peripheral surface of the piston guide 6, and advances and retracts relative to the piston guide 6. The first tubular shaft 3c also slides on a lower end portion of the outer peripheral surface of the stem 5a in the advancing/retracting direction.

The first piston 3 includes the seating portion 3a that seats on the seated portion 6a in the advancing direction and separates from the seated portion 6a in the retracting direction in accordance with the advancing and retracting movement of the holding member 16.

The continuous portion 5b of the holding member 16 includes: an engaging wall 5c having a tubular shape centered on the central axis O radially outward from the stem 5a and extending in the advancing/retracting direction; a connecting wall 5d connecting an upper end portion of the engaging wall 5c and the outer peripheral surface of the stem 5a; and an upper receiving portion 5e protruding radially outward in a stepped shape from an upper end portion of the outer peripheral surface of the engaging wall 5c and receiving an upper end portion of the second urging member 14.

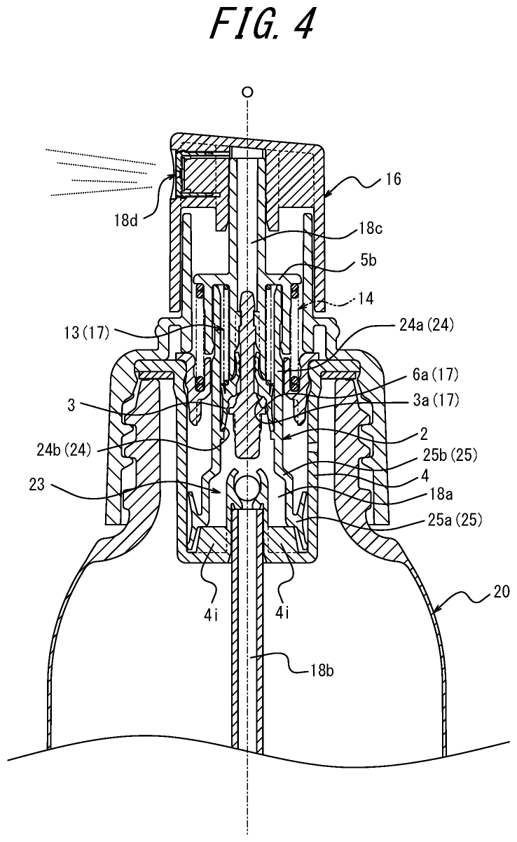

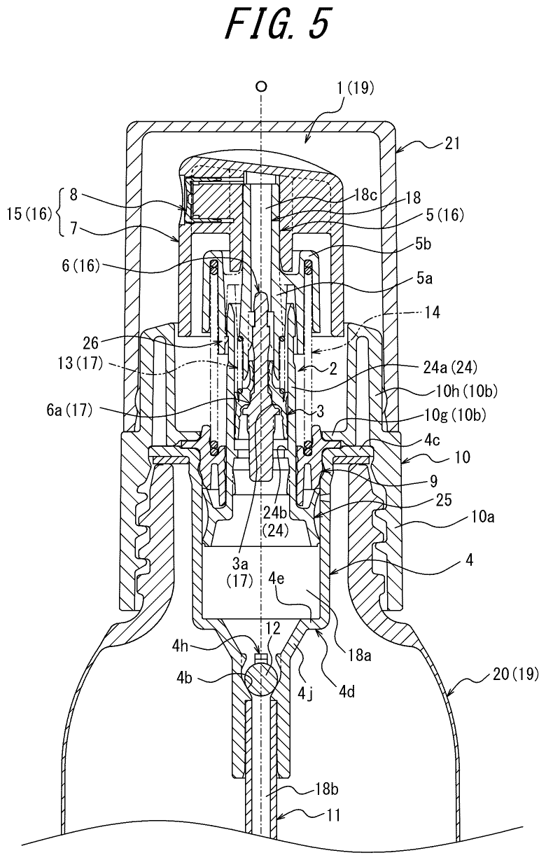

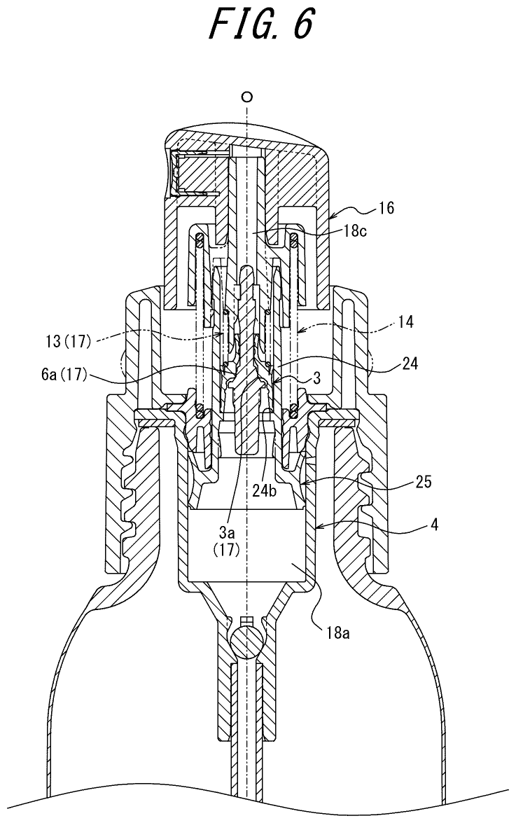

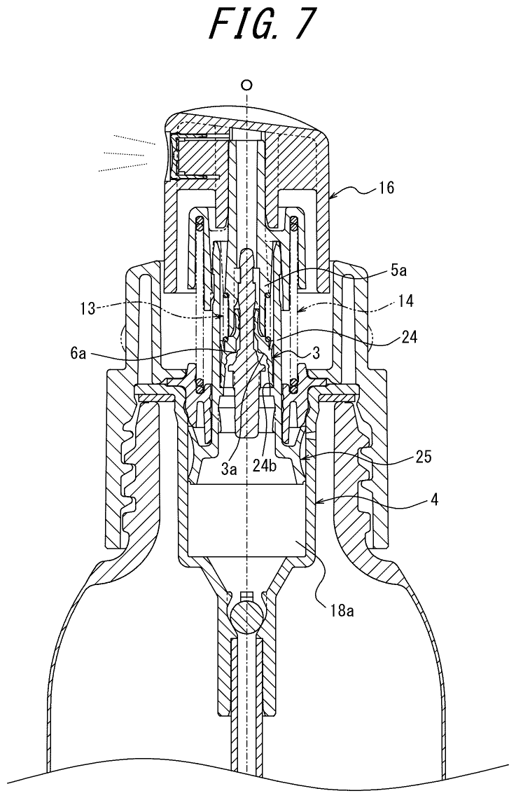

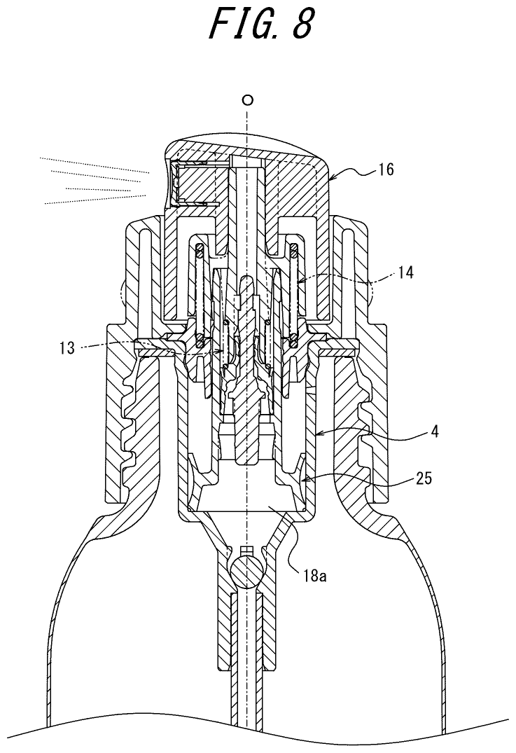

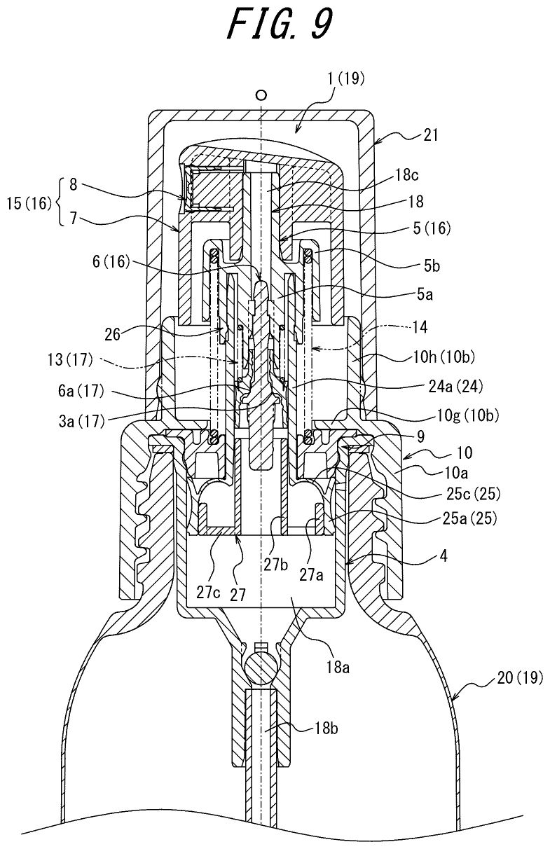

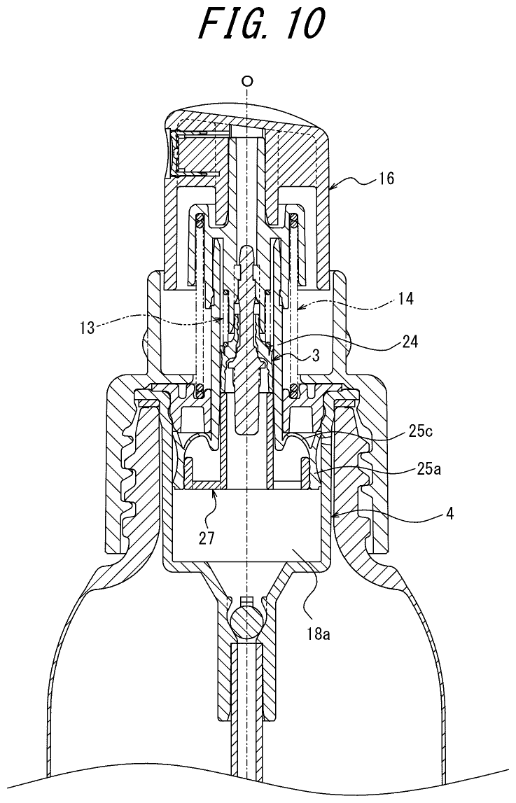

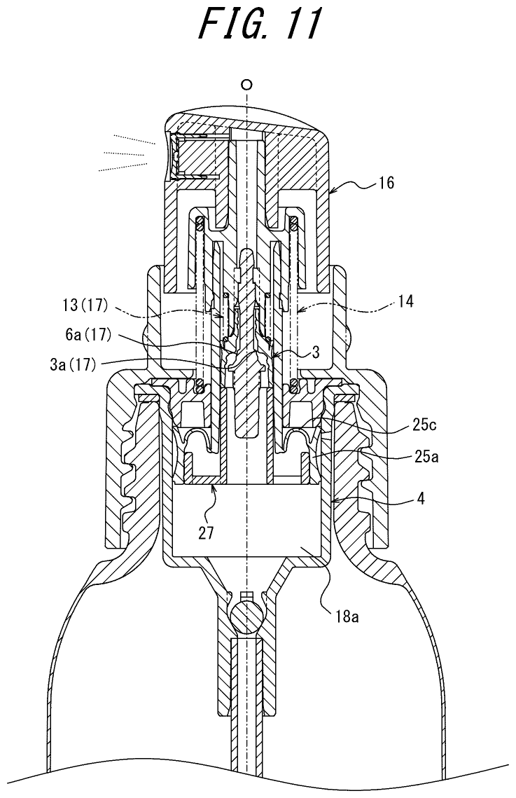

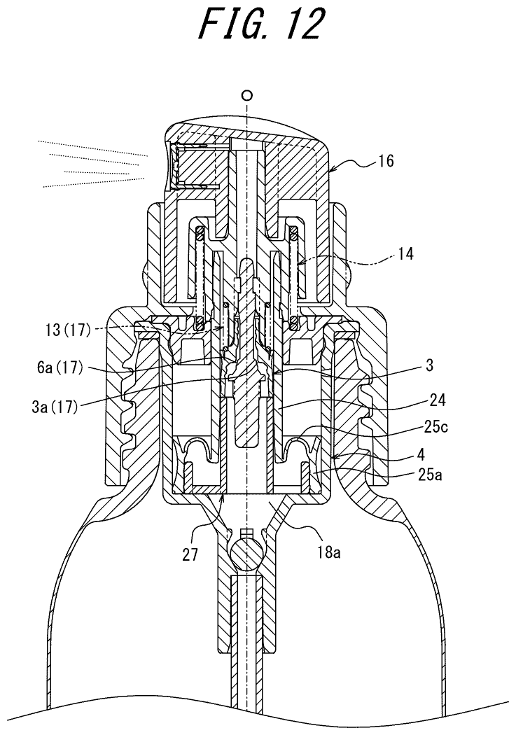

The second urging member 14 urges the first cylinder 24 in the retracting direction via an engaging portion 26 between protruding and recessed portions on the inner peripheral surface of the engaging wall 5c of the continuous portion 5b and the outer peripheral surface of the first cylinder 24. A gap G of a predetermined size is provided between the lower surface of the connecting wall 5d of the continuous portion 5b and the upper end surface of the first cylinder 24 so that the connecting wall 5d of the continuous portion 5b will press the first cylinder 24 in the advancing direction at its advancement limit position relative to the first cylinder 24 (see FIG. 4).

The first urging member 13 includes a compression spring that is compressed by the connecting wall 5d of the continuous portion 5b and the first piston 3 in the advancing/retracting direction.

The head body 7 is attached to an upper end portion of the stem 5a. The nozzle tip 8 is attached within a fitting groove provided on the side surface of the head body 7, so that a flow path for discharging (i.e., spraying) the contents in a mist form through the discharge port 18d is formed between the nozzle tip 8 and the head body 7. The upper surface of the head body 7 forms an operated portion 15a that is subjected to a press-down operation from outside. The nozzle head 15 advances and retracts along with the holding member 16 relative to the second cylinder 4 and the container body 20 in response to the press-down operation.

The internal flow path 18 includes the pump chamber 18a, the upstream flow path 18b located upstream of the pump chamber 18a, and the downstream flow path 18c located downstream of the pump chamber 18a. The pump chamber 18a is defined by the first cylinder 24, the first piston 3, the second cylinder 4, and the second piston 25. The upstream flow path 18b is defined by the pipe 11. The downstream flow path 18c is defined by the first piston 3, the stem 5a, the piston guide 6, and the nozzle head 15. The discharge port 18d is provided in the nozzle tip 8 and is located at the most downstream portion of the downstream flow path 18c.

The pressure accumulating portion 17 closes the downstream flow path 18c of the internal flow path 18 by seating of the seating portion 3a of the first piston 3 in the advancing direction against the seated portion 6a of the holding member 16 due to urging by the first urging member 13.

The upper lid 21 opens and closes the discharge device 1. The upper lid 21 includes a tubular outer peripheral wall 21a centered on the central axis O in a state in which the upper lid 21 closes the discharge device 1, and a top wall 21b connected to an upper end portion of the outer peripheral wall 21a. A lower end portion of the outer peripheral wall 21a is detachably attached to the outer peripheral surface of the outer tubular wall 10d of the mounting cap 10.

The discharge device 1 according to this embodiment, as a result of being configured as described above, operates in response to a press-down operation as follows.

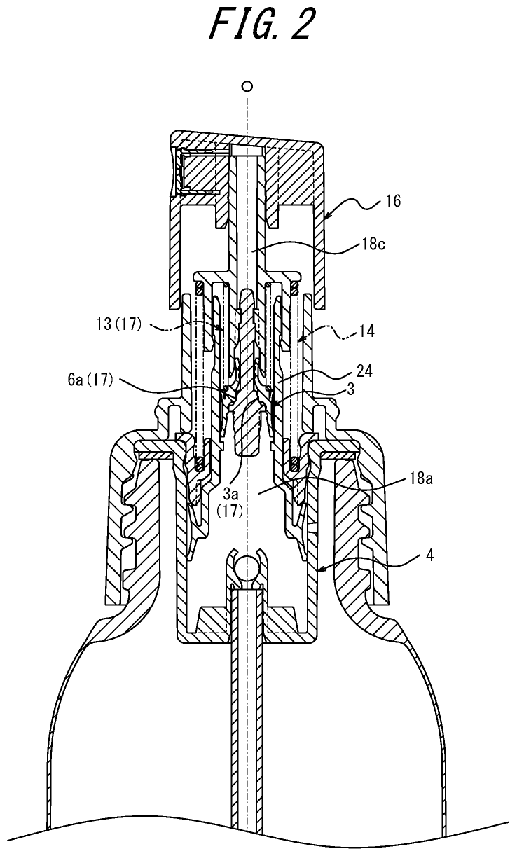

As illustrated in FIG. 2, when the holding member 16 moves in the advancing direction relative to the second cylinder 4 in response to a press-down operation against the urging force of the second urging member 14, first, the holding member 16 advances along with the first piston 3 relative to the first cylinder 24 in a state in which the pressure accumulating portion 17 closes the downstream flow path 18c due to urging by the first urging member 13, so that the internal pressure of the pump chamber 18a increases.

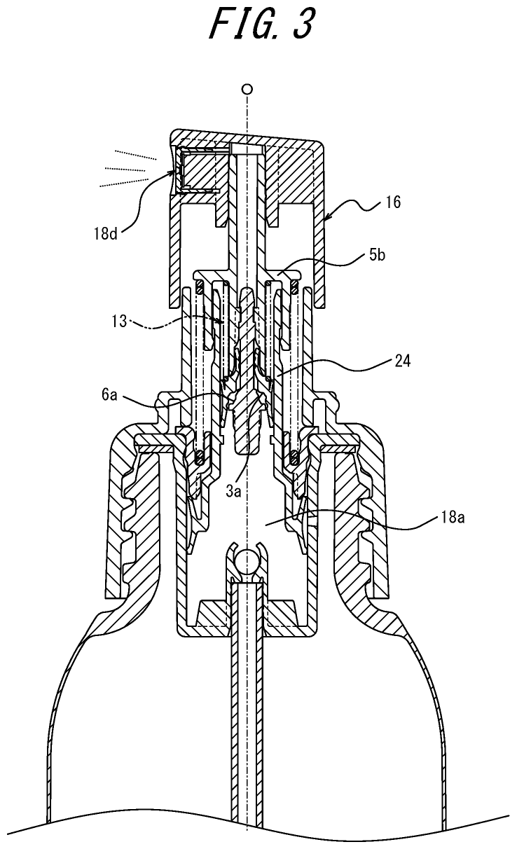

As illustrated in FIG. 3, when the increased internal pressure of the pump chamber 18a causes the seating portion 3a to separate upward from the seated portion 6a against the urging force of the first urging member 13, the contents in the pressure-accumulated pump chamber 18a flow downstream between the seating portion 3a and the seated portion 6a and are vigorously discharged (sprayed) from the discharge port 18d. Thus, vigorous discharge is achieved from an initial stage of the press-down operation, and as a result liquid dripping from the discharge port 18d can be prevented.

With a further press-down operation, the holding member 16 advances relative to the first cylinder 24 to an advancement limit position at which the continuous portion 5b abuts against the upper end of the first cylinder 24. As illustrated in FIG. 4, the continuous portion 5b presses the first cylinder 24 in the advancing direction, thereby causing the holding member 16 to advance along with the first cylinder 24 and the second piston 25 relative to the second cylinder 4. As a result, the contents in the pump chamber 18a flow downstream between the seating portion 3a and the seated portion 6a and are vigorously discharged (sprayed) from the discharge port 18d. Thus, vigorous discharge is achieved even after the initial stage of the press-down operation, and as a result liquid dripping from the discharge port 18d can be prevented. At this time, the first piston 3 abuts against the restricting stepped portion 24b in the advancing direction, thereby keeping the seating portion 3a separated from the seated portion 6a in the retracting direction. This suppresses an increase in the pressing force required for the press-down operation.

When the holding member 16, along with the second piston 25, reaches the advancement limit position relative to the second cylinder 4, a lower end portion of the second tubular shaft 25b abuts against the upper surfaces of the plurality of longitudinal ribs 4i, thereby restricting further advancement.

When the press-down operation is released, first, the holding member 16 retracts relative to the first cylinder 24 due to the urging force of the second urging member 14, and the seating portion 3a seats on the seated portion 6a due to the urging force of the first urging member 13 to close the downstream flow path 18c. Subsequently, in the seated state, the holding member 16, the first piston 3, and the first cylinder/second piston member 2 retract relative to the second cylinder 4 to the positions before the press-down operation due to the urging force of the second urging member 14. The retracting movement causes the internal pressure of the pump chamber 18a to decrease, so that the inlet valve 23 opens. This allows the contents to flow from inside the container body 20 into the pump chamber 18a through the upstream flow path 18b.

According to this embodiment, in the initial stage of the press-down operation, a small amount of contents pressure-accumulated by the pressure accumulating portion 17 can be vigorously discharged by the first cylinder 24 and the first piston 3. After the initial stage of the press-down operation, a large amount of contents can be vigorously discharged by the second cylinder 4 and the second piston 25. Thus, according to this embodiment, a large discharge (spray) volume can be easily achieved while suppressing both an increase in cylinder stroke and an increase in pressing operation force.

The present disclosure is not limited to the aforementioned embodiment, and various modifications can be made without departing from the gist of the present disclosure.

Hence, the discharge device 1 according to the aforementioned embodiment may be modified as long as it includes: a first cylinder 24; a first piston 3 configured to slide on the first cylinder 24; a second cylinder 4 attached to a mouth 20a of a container body 20; a second piston 25 configured to slide on the second cylinder 4; a holding member 16 configured to advance and retract along with the first cylinder 24 and the second piston 25 relative to the second cylinder 4 in response to an external operation and, during the advancement and retraction, advance and retract along with the first piston 3 relative to the first cylinder 24; an internal flow path 18 through which contents inside the container body 20 are discharged via a pump chamber 18a defined by the first cylinder 24, the first piston 3, the second cylinder 4, and the second piston 25, in accordance with the advancement and retraction of the holding member 16; a pressure accumulating portion 17 configured to close the internal flow path 18 by seating of a seating portion 3a of the first piston 3 in an advancing direction against a seated portion 6a of the holding member 16 due to urging by a first urging member 13; and a second urging member 14 configured to urge the holding member 16 in a retracting direction relative to the second cylinder 4.

For example, the discharge device 1 is not limited to a configuration in which the contents are discharged through the discharge port 18d in a mist form. The discharge device 1 is also not limited to a configuration in which the second urging member 14 urges the first cylinder 24 in the retracting direction via the engaging portion 26 between the continuous portion 5b and the first cylinder 24. The discharge device 1 is also not limited to a configuration in which the continuous portion 5b presses the first cylinder 24 in the advancing direction at the advancement limit position relative to the first cylinder 24. The first cylinder 24 is not limited to a configuration including the restricting stepped portion 24b. The second cylinder bottom portion 4d is not limited to a configuration including the plurality of longitudinal ribs 4i.

In the discharge device 1 according to the aforementioned embodiment having the above configuration, it is preferable that the holding member 16 includes: a stem 5a being tubular and extending in an advancing/retracting direction; a piston guide 6 attached to an inner peripheral surface of the stem 5a and including the seated portion 6a; and a continuous portion 5b provided integrally on the stem 5a radially outward from the stem 5a and configured to be urged in the retracting direction by the second urging member 14. The holding member 16 is not limited to a configuration including the nozzle head 15. The discharge device 1 is not limited to a nozzle head type in which the contents are discharged by pressing down the nozzle head 15, and may be, for example, a trigger type in which the contents are discharged by pulling a trigger. The continuous portion 5b and the stem 5a may be formed as separate bodies and assembled together to form the stem member 5.

In the discharge device 1 according to the aforementioned embodiment having the above configuration, it is preferable that the first urging member 13 includes a compression spring configured to be compressed by the continuous portion 5b and the first piston 3 in the advancing/retracting direction.

In the discharge device 1 according to the aforementioned embodiment having the above configuration, it is preferable that the continuous portion 5b is configured to press the first cylinder 24 in the advancing direction at an advancement limit position relative to the first cylinder 24.

In the discharge device 1 according to the aforementioned embodiment having the above configuration, it is preferable that the second urging member 14 is configured to urge the first cylinder 24 in the retracting direction via an engaging portion 26 between the continuous portion 5b and the first cylinder 24.

In the discharge device 1 according to the aforementioned embodiment having the above configuration, it is preferable that the internal flow path 18 includes a discharge port 18d through which the contents are discharged in a mist form.

### REFERENCE SIGNS LIST

1 Discharge device
2 First cylinder/second piston member
3 First piston
3a Seating portion
3b First sliding tube
3c First tubular shaft
4 Second cylinder
4a Inlet port
4b Second cylinder body
4c Flange
4d Second cylinder bottom portion
4e Bottom wall
4f Bottom tubular portion
4g Valve seat portion
4h Valve restricting portion
4i Longitudinal rib
5 Stem member
5a Stem
5b Continuous portion
5c Engaging wall
5d Connecting wall
5e Upper receiving portion
6 Piston guide
6a Seated portion
6b Large-diameter portion
7 Head body
8 Nozzle tip
9 Locking member
9a Locking portion
9b Protruding portion
9c Lower receiving portion
10 Mounting cap
10a Peripheral wall
10b Cap upper portion
10c Lower annular wall
10c Outer tubular wall
10e Upper annular wall
10f Inner tubular wall
11 Pipe
12 Valve body
13 First urging member
14 Second urging member
15 Nozzle head
15a Operated portion
16 Holding member
17 Pressure accumulating portion
18 Internal flow path
18a Pump chamber
18b Upstream flow path
18c Downstream flow path
18d Discharge port
19 Discharge container
20 Container body
20a Mouth
20b Body
21 Upper lid
21a Outer peripheral wall
21b Top wall
22 Packing
23 Inlet valve
24 First cylinder
24a First cylinder body
24b Restricting stepped portion
25 Second piston
25a Second sliding tube
25b Second tubular shaft
26 Engaging portion
G Gap
O Central axis

1. A discharge device comprising:
a first cylinder;
a first piston configured to slide on the first cylinder;
a second cylinder attached to a mouth of a container body;
a second piston configured to slide on the second cylinder;
a holding member configured to advance and retract along with the first cylinder and the second piston relative to the second cylinder in response to an external operation and, during the advancement and retraction, advance and retract along with the first piston relative to the first cylinder;
an internal flow path through which contents inside the container body are discharged via a pump chamber defined by the first cylinder, the first piston, the second cylinder, and the second piston, in accordance with the advancement and retraction of the holding member;
a pressure accumulating portion configured to close the internal flow path by seating of a seating portion of the first piston in an advancing direction against a seated portion of the holding member due to urging by a first urging member; and
a second urging member configured to urge the holding member in a retracting direction relative to the second cylinder.

2. The discharge device according to claim 1, wherein the holding member includes: a stem being tubular and extending in an advancing/retracting direction; a piston guide attached to an inner peripheral surface of the stem and including the seated portion; and a continuous portion provided integrally on the stem radially outward from the stem and configured to be urged in the retracting direction by the second urging member.

3. The discharge device according to claim 2, wherein the first urging member includes a compression spring configured to be compressed by the continuous portion and the first piston in the advancing/retracting direction.

4. The discharge device according to claim 2 or 3, wherein the continuous portion is configured to press the first cylinder in the advancing direction at an advancement limit position relative to the first cylinder.

5. The discharge device according to any one of claims 2 to 4, wherein the second urging member is configured to urge the first cylinder in the retracting direction via an engaging portion between the continuous portion and the first cylinder.

6. The discharge device according to any one of claims 1 to 5, wherein the internal flow path includes a discharge port through which the contents are discharged in a mist form.
